(19) United States
(12) Patent Application Publication
(10) Pub. No.: US 2014/0339331 A1
(43) Pub. Date: Nov. 20, 2014

(54) SOURCE GAS JETTING NOZZLE FOR A VACUUM DEPOSITION APPARATUS

(71) Applicant: AbyzR Co., Ltd., Hwaseong-si (KR)

(72) Inventors: Taekwon Hong, Seongnam-si (KR); Jaebok Song, Seoul (KR)

(73) Assignee: AbyzR Co., Ltd., Hwaseong-si (KR)

(21) Appl. No.: 14/275,856

(22) Filed: May 12, 2014

(30) Foreign Application Priority Data
May 14, 2013 (KR) 10-2013-0054552

(51) Int. Cl. B05B 1/00

(52) U.S. Cl. CPC B05B 1/005
USPC 239/133

(57) ABSTRACT

Disclosed is a source gas jetting nozzle which includes a first gas pipe having one portion connected to a source gas supplier for supplying a source gas, including a first heater inside the first gas pipe, and including a first jetting hole formed on an outer surface of the first gas pipe, for jetting the source gas introduced from the source gas supplier, and a second gas pipe including the first gas pipe inside the second gas pipe, and including a plurality of second jetting holes formed on an outer surface of the second gas pipe, for jetting the source gas introduced from the first gas pipe.

### CROSS-REFERENCE TO RELATED APPLICATION

This application claims the benefit of Korean Patent Application No. 10-2013-0054552, filed on May 14, 2013, which is hereby incorporated by reference as if fully set forth herein.

### BACKGROUND OF THE INVENTION

1. Field of the Invention

The present invention relates to a source gas jetting nozzle for a vacuum deposition apparatus, and more particularly, to a source gas jetting nozzle for a vacuum deposition apparatus, in which more jetting holes for jetting a source gas are formed nearer to both ends of a gas pipe for transferring the source gas and thus the source gas can be jetted uniformly onto a surface of a substrate.

2. Discussion of the Related Art

In general, a vacuum deposition apparatus deposits a thin film on a substrate using a source gas generated by vaporizing a source material. More specifically, the vacuum deposition apparatus vaporizes the source material in vacuum and deposits the thin film on the substrate by jetting the resulting source gas onto the substrate through a jetting nozzle.

A conventional vacuum deposition apparatus includes a first gas pipe having jetting holes formed on its outer surface, for transferring a source gas and jetting the source gas through the jetting holes, and a second gas pipe for jetting the source gas introduced from the first gas pipe onto a surface of a substrate. The first gas pipe is connected, at its portion, to a source gas supplier and receives the source gas from the source gas supplier. The density of the jetting holes is increased farther from the portion of the first gas pipe connected to the source gas supplier or the jetting holes are densely populated at the center of the first gas pipe. Thus, the source gas flowing in the first gas pipe is introduced into the second gas pipe through the jetting holes and then jetted onto the surface of the substrate.

However, in the case where the density of the jetting holes increases farther from the portion of the first gas pipe connected to the source gas supplier, more of the source gas is jetted from the portion of the first gas pipe connected to the source gas supplier than from the other portion of the first gas pipe, which is not connected to the source gas supplier. On the other hand, in the case where the jetting holes are densely populated at the center of the first gas pipe, more of the source gas is jetted from the center of the first gas pipe than from both ends of the first gas pipe. Due to the non-uniform jetting of the source gas from the first gas pipe, the jetting nozzle has limitations in uniformly jetting the source gas onto the surface of the substrate.

### SUMMARY OF THE INVENTION

Accordingly, the present invention is directed to a source gas jetting nozzle for a vacuum deposition apparatus that substantially obviates one or more problems due to limitations and disadvantages of the related art.

An object of the present invention is to provide a source gas jetting nozzle for a vacuum deposition apparatus, which can uniformly distribute a source gas across a substrate.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a source gas jetting nozzle for a vacuum deposition apparatus includes a first gas pipe having one portion connected to a source gas supplier for supplying a source gas, including a first heater inside the first gas pipe, and a first jetting hole formed on an outer surface of the first gas pipe, for jetting the source gas introduced from the source gas supplier, and a second gas pipe including the first gas pipe inside of the second gas pipe, and a plurality of second jetting holes formed on an outer surface of the second gas pipe, for jetting the source gas introduced from the first gas pipe. A density of the plurality of second jetting holes is increased farther from a center of the second gas pipe.

The first jetting hole may be formed at a center of the outer surface of the first gas pipe.

The plurality of second jetting holes may be formed at a smaller interval farther from a center of the second gas pipe.

The first gas pipe may further include a temperature sensor included inside of the first gas pipe, apart from the first heater by a predetermined distance.

The first jetting hole and the plurality of second jetting holes may face each other with the first heater in between.

The first gas pipe and the second gas pipe may be made of quartz.

The source gas jetting nozzle may further include a third gas pipe including the second gas pipe inside the third gas pipe, and including a third jetting hole formed on an outer surface of the third gas pipe, for jetting the source gas introduced from the second gas pipe.

The first gas pipe, the second gas pipe, and the third gas pipe may be made of made of quartz.

The source gas jetted through the first jetting hole may be introduced into a space between the outer surface of the first gas pipe and an inner surface of the second gas pipe, and the source gas jetted through the second jetting holes may be introduced into a space between the outer surface of the second gas pipe and an inner surface of the third gas pipe.

The first jetting hole and the second jetting holes may face each other with the first heater in between, and the second jetting holes and the third jetting hole may face each other with the first heater in between.

The source gas jetting nozzle may further include a jetting shade formed on the outer surface of the third gas pipe, for guiding a jetting direction of the source gas.

The source gas jetting nozzle may further include a second heater disposed at a predetermined position of the outer surface of the third gas pipe.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a source gas jetting nozzle for a vacuum deposition apparatus according to an embodiment of the present invention.

FIG. 2 is a sectional view of the source gas jetting nozzle for a vacuum deposition apparatus, taken along line II-II illustrated in FIG. 1 according to the embodiment of the present invention.

FIG. 3 is a plan view of a second gas pipe illustrated in FIG. 1.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned.

With reference to the attached drawings, a source gas jetting nozzle for a vacuum deposition apparatus according to an embodiment of the present invention will be described below in detail.

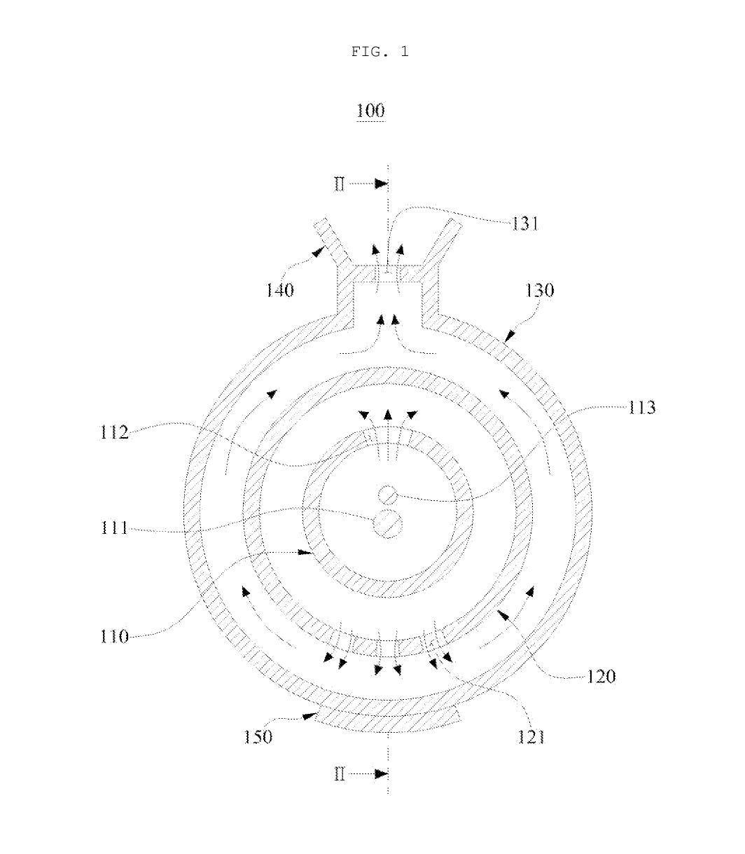

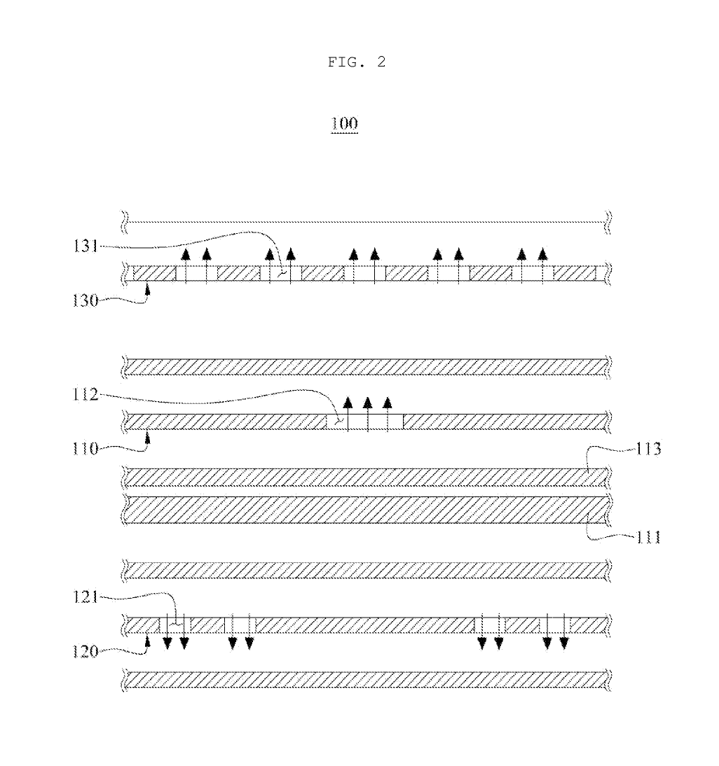

FIG. 1 is a sectional view of a source gas jetting valve 100 for a vacuum deposition apparatus according to an embodiment of the present invention, and FIG. 2 is a sectional view of the source gas jetting valve 100 for a vacuum deposition apparatus, taken along line II-II illustrated in FIG. 1 according to the embodiment of the present invention.

Referring to FIGS. 1 and 2, the source gas jetting valve 100 for a vacuum deposition apparatus according to an embodiment of the present invention may be configured so as to include a first gas pipe 110 and a second gas pipe 120. The first gas pipe 110 is connected, at a portion of the first gas pipe 110, to a source gas supplier (not shown), accommodates a first heater 111 in the first gas pipe 110, and includes a first jetting hole 112 formed on an outer surface of the first gas pipe 110, for jetting a source gas received from the source gas supplier. The second gas pipe 120 accommodates the first gas pipe 110 inside it and includes a plurality of second jetting holes 121 formed on an outer surface of the second gas pipe 120, for jetting the source gas introduced from the first gas pipe 110.

The first gas pipe 110 may be formed into the shape of a pillar. For example, the first gas pipe 110 may be shaped into a square pillar or a cylinder. For the convenience of description, the following description will be given with the appreciation that the first gas pipe 110 is cylindrical, by way of example.

The first gas pipe 110 may be formed into a cylinder. The first gas pipe 110 may be hollow inside it so that the source gas supplied from the source gas supplier may flow in the first gas pipe 110. Since the first gas pipe 110 is hollow inside it, the source gas introduced into the first gas pipe 110 may flow from the one portion of the first gas pipe 110 connected to the source gas supplier to the other portion of the first gas pipe 110. The first gas pipe 110 may be made of quartz with high thermal stability. Accordingly, distortion of the first gas pipe 110 caused by the source gas generated at high temperature can be prevented.

The first heater 111 may be included inside of the first gas pipe 110. The first heater 111 may be included inside the first gas pipe 110, apart from an inner surface of the first gas pipe 110 by a predetermined distance. Being included inside the gas pipe 110, the first heater 111 may transfer a predetermined amount of heat to the source gas flowing through the first gas pipe 110, to thereby compensate for heat loss of the source gas during flowing in the first gas pipe 110. The heater 111 may include a heat line inside of it to generate a predetermined amount of heat, to which the present invention is not limited. Further, the present invention may include any component and device for generating heat in the first heater 111. Therefore, the source gas flowing through the first gas pipe 110 is kept at a predetermined temperature. Due to the resulting unchanged energy state, the source gas may be maintained stable.

The first heater 111 may be divided into a predetermined number of sections along a longitudinal direction of the first gas pipe 110, inside the first gas pipe 110 and temperature may be controlled independently in each section of the first heater 111. Accordingly, the source gas jetting nozzle 100 for a vacuum deposition apparatus according to the present invention can readily compensate for heat loss of the source gas flowing through the first gas pipe 110.

The first gas pipe 110 may further include a temperature sensor 113. The temperature sensor 113 may be included inside the first gas pipe 110, apart from the first heater 111 by a predetermined distance. The temperature sensor 113 may measure inner temperatures of the first gas pipe 110 in the sections of the first heater 111. The temperature sensor 113 may measure the inner temperatures of the first gas pipe 110 in which the sections of the first heater 111 are positioned and may generate temperature data based on the inner temperature measurements. A user may receive the temperature data from the temperature sensor 113 and may control each section of the first heater 111 by checking the inner temperatures of the first gas pipe 110 corresponding to the sections of the first heater 111. Therefore, the source gas jetting nozzle 100 for a vacuum deposition apparatus according to the present invention can more effectively compensate for heat loss of the source gas flowing through the first gas pipe 110.

The first jetting hole 112 may be formed at the center of the outer surface of the first gas pipe 110. The first jetting hole 112 may be formed at the center of the outer surface of the first gas pipe 110 along the longitudinal direction of the first gas pipe 110. The first jetting hole 112 may penetrate through the outer surface of the first gas pipe 110. Accordingly, the source gas flowing through the first gas pipe 110 may be jetted outside the first gas pipe 110 through the first jetting hole 112.

The second gas pipe 120 may be formed into the shape of a pillar. For example, the second gas pipe 120 may be shaped into a square pillar or a cylinder. For the convenience of description, the following description will be given with the appreciation that the second gas pipe 120 is cylindrical, by way of example.

The second gas pipe 120 may be formed into a cylinder. The second gas pipe 120 may be hollow inside it. A cross section of the second gas pipe 120 may have a larger diameter than a cross section of the first gas pipe 110. Thus, the first gas pipe 110 may be included inside the second gas pipe 120 and the source gas jetted from the first gas pipe 110 may be introduced into a space between the outer surface of the first gas pipe 110 and an inner surface of the second gas pipe 120. The second gas pipe 120 may be made of quartz with higher thermal stability. Therefore, distortion of the second gas pipe 120 caused by the temperature of the source gas introduced from the first gas pipe 110 can be prevented.

The plurality of second jetting holes 120 may be formed on the outer surface of the second gas pipe 120. The plurality of second jetting holes 120 and the first jetting hole 112 may be formed respectively on the outer surface of the second gas pipe 120 and the outer surface of the first gas pipe 120, facing each other with the first heater 111 in between. Consequently, since the source gas is jetted from the first jetting hole 112 and the second jetting holes 121 in opposite directions, the source gas may travel along a maximum path in the source gas jetting nozzle 100 for a vacuum deposition apparatus. That is, as the travel path of the source gas is maximized in the source gas jetting nozzle 100 for a vacuum deposition apparatus, the source gas can be more uniformly jetted from the source gas jetting nozzle 100 for a vacuum deposition apparatus.

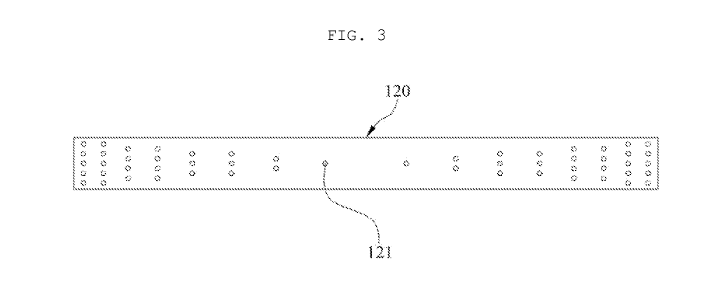

FIG. 3 is a plan view of the second gas pipe 120 illustrated in FIG. 1.

Referring to FIG. 3, the plurality of second jetting holes 121 may be formed on the outer surface of the second gas pipe 120 in such a manner that the density of the second jetting holes 121 increases farther from the center of the second gas pipe 120. In addition, the distance between the second jetting holes 121 may be decreased father from the center of the second gas pipe 120. That is, the plurality of second jetting holes 121 may be formed in triangles on the outer surface of the second gas pipe 120. The second gas pipe 120 may jet the source gas onto a substrate (not shown) placed under the second jetting holes 121. Since the density of the second jetting holes 121 formed on the outer surface of the second gas pipe 120 increases farther from the center of the second gas pipe 120, the second gas pipe 120 can jet the source gas uniformly across the substrate.

More specifically, the pressure of the source gas jetted from the first gas pipe 110 having the first jetting holes 112 formed at the center of its outer surface may be highest at the center of the second gas pipe 120. Herein, more second jetting holes 121 may be formed at both ends of the second gas transfer pipe 120 than at the center of the second gas transfer pipe 120. That is, although the source gas is introduced with highest pressure at the center of the second gas pipe 120, a small amount of the source gas may be jetted through a plurality of second jetting holes 121 formed at the center of the second gas pipe 120 because a small number of second jetting holes 121 are formed at the center of the second gas pipe 120. On the contrary, the source gas may be introduced into both ends of the second gas pipe 120 at a lower pressure level than the center of the second gas pipe 120. However, since more second jetting holes 121 are formed at both ends of the second gas pipe 120, the second gas pipe 120 may discharge a larger amount of the source gas through the second jetting holes 121 formed at both ends of the second gas pipe 120. Since the source gas is introduced into the center of the second gas pipe 120 at a higher pressure level than into both ends of the second gas pipe 120, similar amounts of the source gas may be discharged from the second jetting holes 121 at the center and both ends of the second gas pipe 120. Consequently, the source gas is discharged uniformly along the longitudinal direction of the second gas pipe 120, thereby enabling uniform jetting of the source gas onto one surface of the substrate.

The source gas jetting nozzle 100 for a vacuum deposition apparatus according to the present invention further includes a third gas pipe 130. In this case, the substrate may be disposed under a third jetting hole 131 of the third gas pipe 130. That is, the source gas jetted from the second gas pipe 120 may be jetted onto the substrate through the third gas pipe 130.

More specifically, the third gas pipe 130 may be formed into the shape of a pillar. For example, the third gas pipe 130 may be shaped into a square pillar or a cylinder. For the convenience of description, the following description will be given with the appreciation that the third gas pipe 130 is cylindrical, by way of example.

The third gas pipe 130 may be formed into a cylinder. The third gas pipe 130 may be hollow inside it. A cross section of the third gas pipe 130 may have a larger diameter than the cross section of the second gas pipe 120. Thus, the second gas pipe 120 may be included inside the third gas pipe 130 and the source gas jetted from the second gas pipe 120 may be introduced into a space between the outer surface of the second gas pipe 120 and an inner surface of the third gas pipe 130. The third gas pipe 130 may be made of quartz with high thermal stability. Accordingly, distortion of the third gas pipe 130 caused by the temperature of the source gas introduced from the second gas pipe 120 can be prevented.

The third jetting hole 131 may be formed on the outer surface of the third gas pipe 130. The third jetting hole 130 may be extended on the outer surface of the third gas pipe 130 along the longitudinal direction of the third gas pipe 130. Or a plurality of third jetting holes 131 may be formed on the outer surface of the third gas pipe 130, apart from each other by a predetermined distance along the longitudinal direction of the third gas pipe 130. However, the present invention is not limited to the above examples. For the convenience of description, the following description will be given in the context of a plurality of third jetting holes 131 spaced from each other by a predetermined distance along the longitudinal direction of the third gas pipe 130 on the outer surface of the third gas pipe 130.

The plurality of third jetting holes 131 may be formed on the outer surface of the third gas pipe 130. The third jetting holes 131 and the second jetting holes 121 may be formed respectively on the outer surfaces of the third and second gas pipes 130 and 120, facing each other with the first heater 111 in between. Consequently, since the source gas is jetted from the second jetting holes 121 and the third jetting holes 131 in opposite directions, the source gas may travel along a longer path in the source gas jetting nozzle 100 for a vacuum deposition apparatus. Due to the lengthened travel path of the source gas in the source gas jetting nozzle 100 for a vacuum deposition apparatus, the source gas can be jetted more uniformly from the source gas jetting nozzle 100 for a vacuum deposition apparatus. Consequently, the uniform jetting of the source gas onto the substrate leads to an increased quality of a thin film formed by jetting the source gas.

The source gas jetting valve 100 for a vacuum deposition apparatus further includes a jetting shade 140. The jetting shade 140 may be formed on the outer surface of the third gas pipe 130. The jetting shade 140 may be stretched out at a predetermined angle with respect to the outer surface of the third gas pipe 130. The jetting shade 140 may guide a direction in which the source gas jetted from the third jetting holes 131 is spread. Therefore, the source gas jetting valve 100 for a vacuum deposition apparatus can effectively jet the source gas onto the substrate.

The source gas jetting valve 100 for a vacuum deposition apparatus further includes a second heater 150. The second heater 150 may be disposed at a predetermined position of the outer surface of the third gas pipe 130. The second heater 150 may compensate for heat loss of the source gas flowing through the third gas pipe 130. The second heater 150 may include a heat line for generating a predetermined amount of heat inside it, which should not be construed as limiting the present invention. Further, the present invention may include any component and device for generating heat in the second heater 150. As the second heater 150 transfers a predetermined amount of heat to the outer surface of the third gas pipe 130, the predetermined amount of heat may be transferred to the source gas flowing inside the third gas pipe 130. That is, since the predetermined amount of heat generated from the second heater 150 is transferred to the source gas through the third gas pipe 130, heat loss of the source gas during flowing through the third gas pipe 130 can be prevented. Therefore, the source gas flowing through the third gas pipe 130 is kept at a predetermined temperature. The resulting unchanged energy state maintains the source gas stable.

As is apparent from the above description, because the plurality of second jetting holes are formed with a higher density farther from the center of the second gas pipe in the source gas jetting nozzle for a vacuum deposition apparatus according to the embodiment of the present invention, similar amounts of a source gas can be discharged from the center of the second gas pipe and both ends of the second gas pipe in which the source gas is introduced from the first gas pipe at a relatively low pressure level. That is, the source gas jetting nozzle for a vacuum deposition apparatus according to the embodiment of the present invention can jet the source gas uniformly onto a substrate placed under the second gas pipe.

Further, as the source gas jetting nozzle for a vacuum deposition apparatus according to the embodiment of the present invention jets the source gas uniformly, a thin film can be formed to a uniform thickness on the substrate.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A source gas jetting nozzle for a vacuum deposition apparatus, comprising:
a first gas pipe having one portion connected to a source gas supplier, including a first heater inside of the first gas pipe, and a first jetting hole formed on an outer surface of the first gas pipe, for jetting a source gas introduced from the source gas supplier; and
a second gas pipe including the first gas pipe inside of the second gas pipe, and a plurality of second jetting holes formed on an outer surface of the second gas pipe, for jetting the source gas introduced from the first gas pipe,
wherein a density of the plurality of second jetting holes is increased farther from a center of the second gas pipe gradually.

2. The source gas jetting nozzle according to claim 1, wherein the first jetting hole is formed at a center of the outer surface of the first gas pipe.

3. The source gas jetting nozzle according to claim 1, wherein the plurality of second jetting holes is formed at a smaller interval farther from a center of the second gas pipe gradually.

4. The source gas jetting nozzle according to claim 1, wherein the first gas pipe further includes a temperature sensor included inside the first gas pipe, apart from the first heater by a predetermined distance.

5. The source gas jetting nozzle according to claim 1, wherein the first jetting hole and the plurality of second jetting holes face each other with the first heater in between.

6. The source gas jetting nozzle according to claim 1, wherein the first gas pipe and the second gas pipe are made of quartz.

7. The source gas jetting nozzle according to claim 1, further comprising a third gas pipe including the second gas pipe inside of the third gas pipe, and a third jetting hole formed on an outer surface of the third gas pipe, for jetting the source gas introduced from the second gas pipe.

8. The source gas jetting nozzle according to claim 7, wherein the first gas pipe, the second gas pipe, and the third gas pipe are made of quartz.

9. The source gas jetting nozzle according to claim 7, wherein the source gas jetted through the first jetting hole is introduced into a space between the outer surface of the first gas pipe and an inner surface of the second gas pipe, and the source gas jetted through the second jetting holes is introduced into a space between the outer surface of the second gas pipe and an inner surface of the third gas pipe.

10. The source gas jetting nozzle according to claim 7, wherein the first jetting hole and the second jetting holes face each other with the first heater in between, and the second jetting holes and the third jetting hole face each other with the first heater in between.

11. The source gas jetting nozzle according to claim 7, further comprising a jetting shade formed on the outer surface of the third gas pipe, for guiding a jetting direction of the source gas.

12. The source gas jetting nozzle according to claim 7, further comprising a second heater disposed at a predetermined position of the outer surface of the third gas pipe.
